(19) United States
(12) Patent Application Publication
(10) Pub. No.: US 2003/0113188 A1
(43) Pub. Date: Jun. 19, 2003

(54) Mechanism for providing a continuous supply of wafers and cassettes to semiconductor fabrication tool

(75) Inventor: Mark Pool, Sunnyvale, CA (US)

Correspondence Address: APPLIED MATERIALS, INC., 2881 SCOTT BLVD. M/S 2061, SANTA CLARA, CA, 95050, US

(73) Assignee: APPLIED MATERIALS, INC.

(21) Appl. No.: 10/022,645

(22) Filed: Dec. 17, 2001

(51) Int. Cl. B65G 1/00

(52) U.S. Cl. 414/217

(57) ABSTRACT

A load lock of a semiconductor processing tool includes a plurality of antechambers selectively isolatable from the main chamber of the load lock. The antechambers can function in tandem, serving as staging areas to enable maximum efficiency of wafer handling as the tool transfers wafers between various processing stages. The antechambers can also operate independently, with one antechamber isolated from the evacuated main load lock chamber and then vented, thereby permitting loading or unloading of cassettes or wafers while the main load lock chamber, the tool, and other antechambers remain occupied with wafer processing. In addition to wafer evacuation/venting, load lock antechambers in accordance with embodiments of the present invention may host a variety of other pre- or post-processing activities, such as wafer heating/cooling, exposure to purge/ambient gases, wafer orientation, wafer center-finding, and metrology.

### BACKGROUND OF THE INVENTION

The present invention relates to equipment used in the manufacture of semiconductor devices. More specifically, the present invention relates to apparatuses and methods enabling high efficiency utilization of wafers and cassettes by a processing tool.

The term “cluster tool” generally refers to a modular, multichamber, integrated processing system having at least one central wafer handling module and a number of peripheral process chambers. Cluster tools have become generally accepted as effective and efficient in the manufacture of advanced microelectronic devices.

FIG. 1 shows a top schematic view of a cluster tool 10 having multiple single wafer processing chambers 12 mounted thereon. A cluster tool similar to that shown in FIG. 1 is available from Applied Materials, Inc. of Santa Clara, Calif. The tool includes load lock chambers 20a and 20b separated from transfer chamber 18 by slit valves 11a and 11b, respectively. Transfer chamber 18 includes a wafer handling robot 16 of the arm/knuckle/wrist type for moving the wafers from location to location within the system, in particular, between the multiple single wafer processing chambers 12. This particular tool is shown to accommodate up to four (4) single wafer processing chambers 12 positioned radially about transfer chamber 18.

Cluster tool 10 is a relatively complex and expensive piece of equipment. It is therefore desirable to optimize throughput of wafers through tool 10. Specifically, it is important to maximize the efficiency of wafer handling by tool 10, such that processing chambers 12 are occupied as continuously as possible, and robot 16 within transfer chamber 18 is continuously occupied and does not make unnecessary transit operations.

However, one bottleneck for wafer handling may occur as wafers are loaded/unloaded from load lock chambers 20a and 20b. Conventionally, the wafer handling efficiency of tool 10 has been optimized by including two separate load locks 20a and 20b, one for receiving incoming wafers to be processed, and the other for transferring completed wafers from tool 10.

While cluster tool architectures employing a dual load lock approach have proven effective, the increasing complexity and variety of different process stages performed by semiconductor processing tools has created a need for more flexible and adaptable wafer handling systems.

In light of the above, improved efficiency in wafer handling by a cluster tool is desirable.

### SUMMARY OF THE INVENTION

Embodiments of the present invention provide a semiconductor fabrication tool load lock that includes a plurality of antechambers selectively isolatable from the main load lock chamber. These antechambers can function in tandem, providing wafer staging areas to enable maximum efficiency of wafer handling as the tool transfers wafers between various processing stages. The load lock antechambers can also operate independently. For example, one antechamber can be isolated from the evacuated main load lock chamber and then vented to permit loading or unloading of cassettes or wafers while the tool, the main load lock chamber, and other load lock antechambers remain occupied with wafer processing/handling. Once reloaded, the first antechamber may be evacuated and returned to contact with the main chamber, while another load lock antechamber is in turn sealed off and vented for wafer/cassette loading or unloading. In addition to wafer evacuation/venting, load lock antechambers in accordance with embodiments for the present invention may also host a variety of other pre-or post-processing activities, including but not limited to wafer heating/cooling, exposure to purge/ambient gases, wafer orientation, wafer center finding, and metrology.

An embodiment of an apparatus for processing a substrate in accordance with the present invention comprises a plurality of processing chambers, a central transfer chamber housing a first robot in selective communication with the processing chambers, and a load lock. The load lock comprises a main chamber including a second robot in selective wafer communication with the first robot through a first slit valve, and a first load lock antechamber configured to receive a first wafer batch, the first load lock antechamber in selective wafer communication with the second robot through a second slit valve. A second load lock antechamber is configured to receive a second wafer batch, the second load lock antechamber in selective wafer communication with the second robot through a third slit valve. The first load lock antechamber and the second load lock antechamber are in fluid communication with a vacuum pump and selectively evacuable from the main chamber and from each other.

An embodiment of a method of processing a substrate comprises loading a first substrate batch from a buffering table into a first load lock antechamber in selective communication with a main load lock chamber through a first slit valve. A first robot positioned within the main load lock chamber is utilized to transfer a substrate from the first antechamber to the main load lock chamber while a second load lock antechamber in selective communication with the main load lock chamber through a second slit valve is loaded or unloaded with a second substrate batch. A second robot positioned within a transfer chamber of the cluster tool in communication with the load lock main chamber and with a processing chamber of the cluster tool, is used to transfer the substrate from the main load lock chamber to the processing chamber.

These and other embodiments of the present invention, as well as its advantages and features, are described in more detail in conjunction with the text below and attached figures.

### BRIEF DESCRIPTION OF THE DRAWINGS

FIG. 1 is a plan view of a cluster tool.

FIG. 2 is a plan view of one embodiment of a load lock structure in accordance with the present invention which utilizes a lateral orientation of antechambers relative to the load lock main chamber.

FIG. 3 is a plan view of another embodiment of a load lock structure in accordance with the present invention which utilizes an orthogonal orientation of antechambers relative to the load lock main chamber.

FIG. 4 is a plan view of yet another embodiment of a load lock structure in accordance with the present invention.

FIG. 5 is a perspective view of yet another embodiment of a load lock structure in accordance with the present invention.

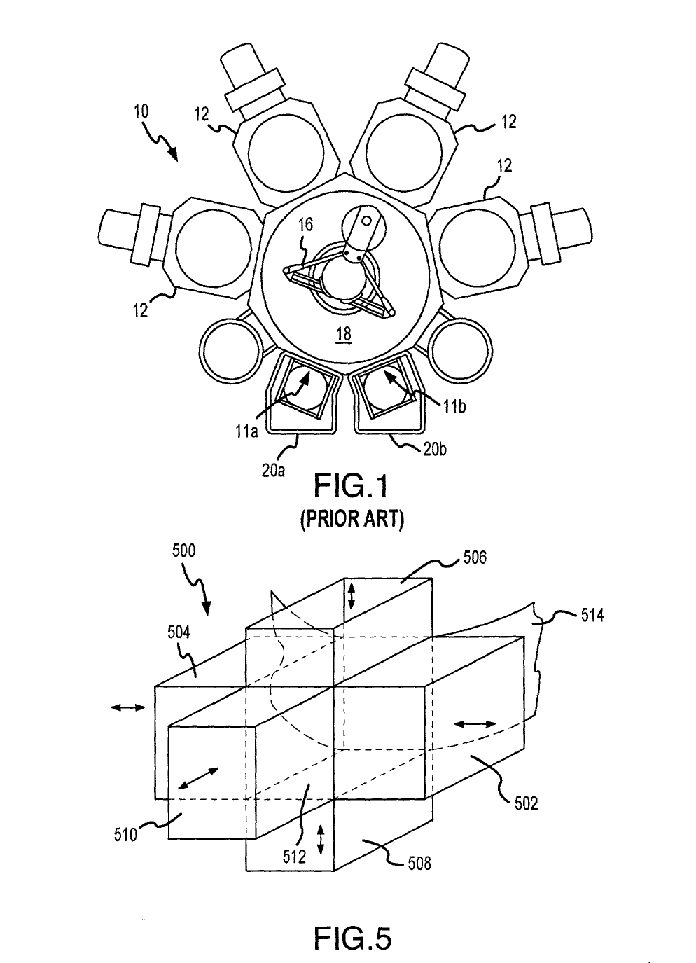

### DESCRIPTION OF THE SPECIFIC EMBODIMENTS

As used in this patent application, the term “batch” refers to the wafer capacity of a load lock antechamber in accordance an embodiment of the present invention. Wafers may be transferred to and from a tool, and held during processing of other wafers, in a common physical container known as a cassette. Depending upon the particular tool design, the capacity of embodiments of load lock antechambers in accordance with the present invention and hence the meaning of the term “batch”, may range from a single wafer to the contents of an entire cassette.

As used in this patent application, the term “communication” refers to the transfer of physical material and/or information from one point to another. Accordingly, the description of one chamber being in communication with a second chamber indicates the ability to transfer semiconductor wafers between the chambers.

Embodiments of the present invention provide a semiconductor fabrication tool load lock that includes a plurality of antechambers selectively isolatable from the main load lock chamber. These antechambers can function in tandem, providing staging areas to enable maximum efficiency of wafer handling as the tool transfers wafers between various processing stages. The load lock antechambers can also operate independently, with one antechamber isolated from the evacuated main load lock chamber and then vented, permitting loading or unloading of wafers from the tool while the tool, the main load lock chamber, and other load lock antechambers remain occupied with wafer handling/processing. Once reloaded, the first antechamber may be evacuated and returned to contact with the main chamber. Independent of loading/unloading of the first antechamber, on demand or according to a predetermined schedule, another antechamber may be sealed off and vented to permit loading or unloading of wafers.

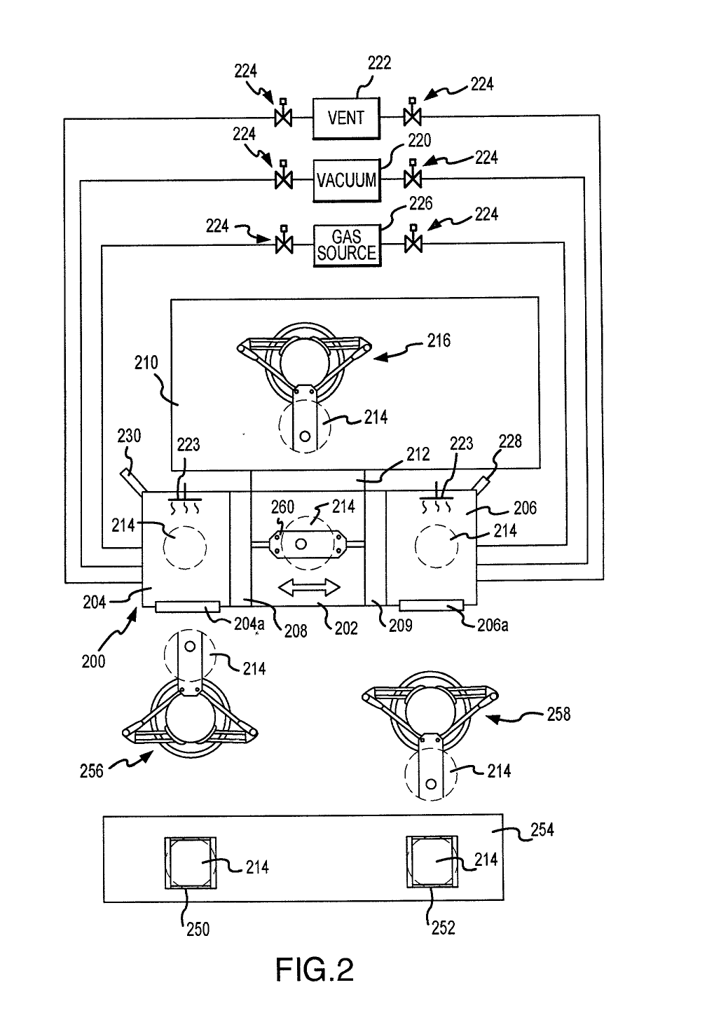

FIG. 2 is a plan view of one embodiment of a load lock structure in accordance with the present invention, which utilizes a lateral orientation of antechambers relative to the main load lock chamber.

Load lock 200 includes main load lock chamber 202 and first load lock antechamber 204. Second load lock antechamber 206 is positioned adjacent to main load lock chamber 202, on the side opposite of first load lock antechamber 204, coplanar with first antechamber 204 and main chamber 202. While FIG. 2 shows an embodiment of a tool featuring a single load lock, other embodiments of tools in accordance with the present invention may include more than one load lock.

Each of load lock antechambers 204 and 206 are in communication with an external wafer supply in the form of first and second cassettes 250 and 252, respectively. Cassettes 250 and 252 are positioned on local buffering table 254 so as to render wafers 214 housed therein accessible to loading robots 256 and 258 respectively, which are of the arm/knuckle/wrist variety. Buffering table 254 typically provides the interface between the cluster tool and other components of the fabrication facility.

Loading robots 256 and 258 transfer batches of wafers to and from load lock antechambers 204 and 206 via access ports 204a and 206a. While loading robots 256 and 258 shown in FIG. 2 are of the rotational arm/knuckle/wrist variety, other types of robots could be employed to perform this function.

Main chamber 202 of load lock 200 is selectively in communication with cluster tool mainframe 210 and cluster tool robot 216 through first slit valve 212. First load lock antechamber 204 is selectively in communication with main load lock chamber 202 through first slit valve 208. Second load lock antechamber 206 is in selective communication with main load lock chamber 202 through second slit valve 209. Slit valves and methods of controlling slit valves are disclosed by Tepman et al. in U.S. Pat. No. 5,226,632 and by Lorimer in U.S. Pat. No. 5,363,872, both of which are assigned to the assignee of the present application and are incorporated by reference herein.

The exchange of wafers between load lock antechambers 204 and 206 and load lock main chamber 202 may be performed by a variety of mechanical devices. As shown in FIG. 2, robot 260 present in load lock main chamber 202 is of the shuttle type that is capable of bi-directional motion along a single line. However, other examples of robots that can be used for transferring wafers between load lock chambers include arm/knuckle robots capable of rotating about a fixed point.

First load lock antechamber 204 and second load lock antechamber 206 are each in selective fluid communication with vacuum source 220, and vent 222 through valves 224. Antechambers 204 and 206 may thus be evacuated and vented independent from one another and from main load lock chamber 202.

During operation of cluster tool 210, batches of wafers 214 are independently loaded by robots 256 and 258 into antechambers 204 and 206 through access ports 204a and 206a, respectively. Wafers 214 are then selectively moved through slit valves 208 or 209 to main load lock chamber 202, and then through slit valve 212 to cluster tool mainframe 210 for processing.

As wafers 214 are routed between the various processing stages of cluster tool 210, they may be housed in antechambers 204 and 206 to await an available tool processing chamber, or to await completion of processing of other wafers. For purposes of maintaining lot uniformity and ensuring error traceability, wafers generally remain associated with the same cassette throughout an entire semiconductor processing sequence.

When all wafers of a particular batch have been processed by the tool and are returned to their respective antechamber 204 or 206, that antechamber may be sealed off from main load lock chamber 202 and vented, while wafers can continue to be processed using the other antechamber. This permits wafers present in the vented antechamber to be off-loaded and replaced with a fresh batch to enable continuous processing by the tool. The previously vented antechamber may then be pumped down and reunited with the still-evacuated main load lock chamber 202. In this manner, ongoing processing of wafers by tool 210 is not disturbed by pump-down and wafer loading/unloading, and high throughout of the tool is preserved. Moreover, because the size of a batch may be less than a full cassette, the volume evacuated from the antechamber may be relatively small, thereby permitting rapid antechamber evacuation and venting.

The precise features of the antechamber interior will vary according to such factors as the batch size, and the pre- or post-processing activities taking place therein (see discussion below). For antechambers receiving single wafer batches, the antechamber will typically include a support member for receiving and retaining the wafer in place during evacuation and venting. For antechambers designed to receive multi-wafer batches numbering less than entire cassette's worth, the antechamber will typically include a plurality of shelves for holding the wafers. For antechambers designed to receive an entire cassette's worth of wafers as a batch, the antechamber will typically include structures to receive and secure the cassette itself within the antechamber. A discussion of the interior features of a typical load lock structure is found in U.S. Pat. No. 5,855,681, assigned to Applied Materials, Inc. This patent is incorporated by reference herein for all purposes.

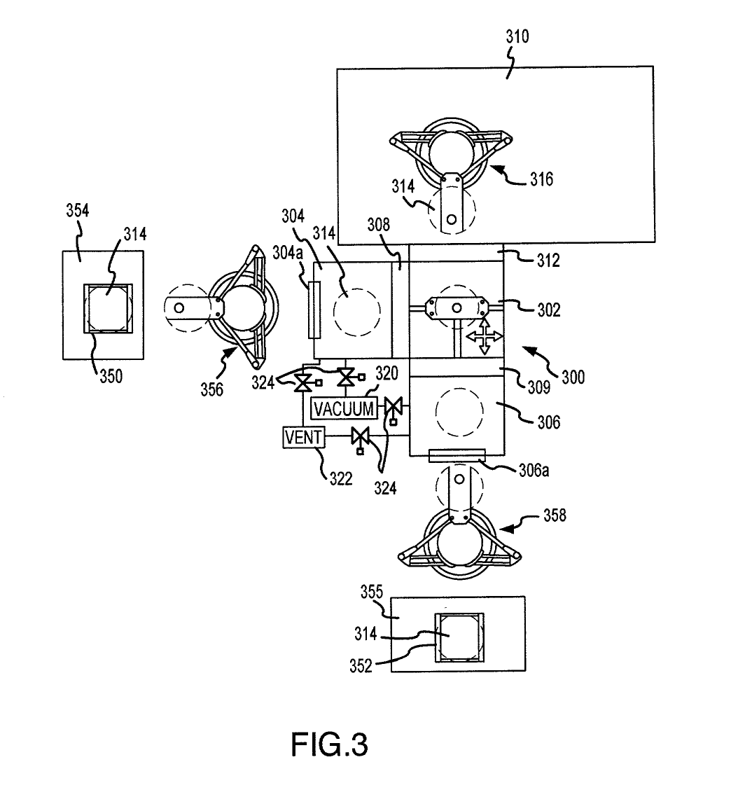

While an embodiment of the present invention has been described in FIG. 2 in conjunction with a load lock having antechambers oriented linear to one another relative to the main load lock chamber, the present invention is not limited to this particular configuration. In an alternative embodiment in accordance with the present invention, load lock antechambers in accordance with the present invention may be oriented perpendicular to one another. This embodiment is illustrated in FIG. 3.

FIG. 3 shows load lock 300 that includes main load lock chamber 302 selectively in active wafer exchange with cluster tool mainframe 310 through slit valve 312. Load lock 300 includes first and second load lock antechambers 304 and 306 coplanar with main chamber 302 and with each other. Antechambers 304 and 306 are disposed orthogonal to one another relative to main load lock chamber 302.

Each of load lock antechambers 304 and 306 are in communication with an external wafer supply in the form of first and second cassettes 350 and 352, respectively. Cassettes 350 and 352 are positioned on local buffering tables 354 and 355 so as to be accessible to loading robots 356 and 358, respectively. Loading robots 356 and 358 transfer wafers to and from load lock antechambers 304 and 306 via access ports 304a and 306a. While loading robots 356 and 358 shown in FIG. 3 are of the rotational arm/knuckle/wrist variety, other types of robots could be employed to perform this function.

First load lock antechamber 304 may selectively communicate wafers to and from main load lock chamber 302 through slit valve 308. Second load lock antechamber 306 may selectively communicate wafers to and from main load lock chamber 302 through slit valve 309. Both first and second antechambers 304 and 306 are in selective communication with vacuum source 320 and vent 322 via valves 324.

The communication of wafers between load lock antechambers 304 and 306 and the main load lock chamber 302 may be accomplished using a variety of mechanical devices. As shown in FIG. 3, robot 360 present in load lock main chamber 302 is of the shuttle type allowing for motion along perpendicular axes. However, other types of robots, such as those employing rotational movement, could also be employed.

Operation of load lock 300 is similar to that of the load lock 200 described above in connection with FIG. 2. Wafers 314 positioned within antechambers 304 and 306 are available to the tool for processing or for storage between processing stages. Moreover, processed wafers within a completed batch can be sealed off in an antechamber, vented, and off-loaded from the tool without disturbing or interfering with processing of wafers provided in the other antechamber.

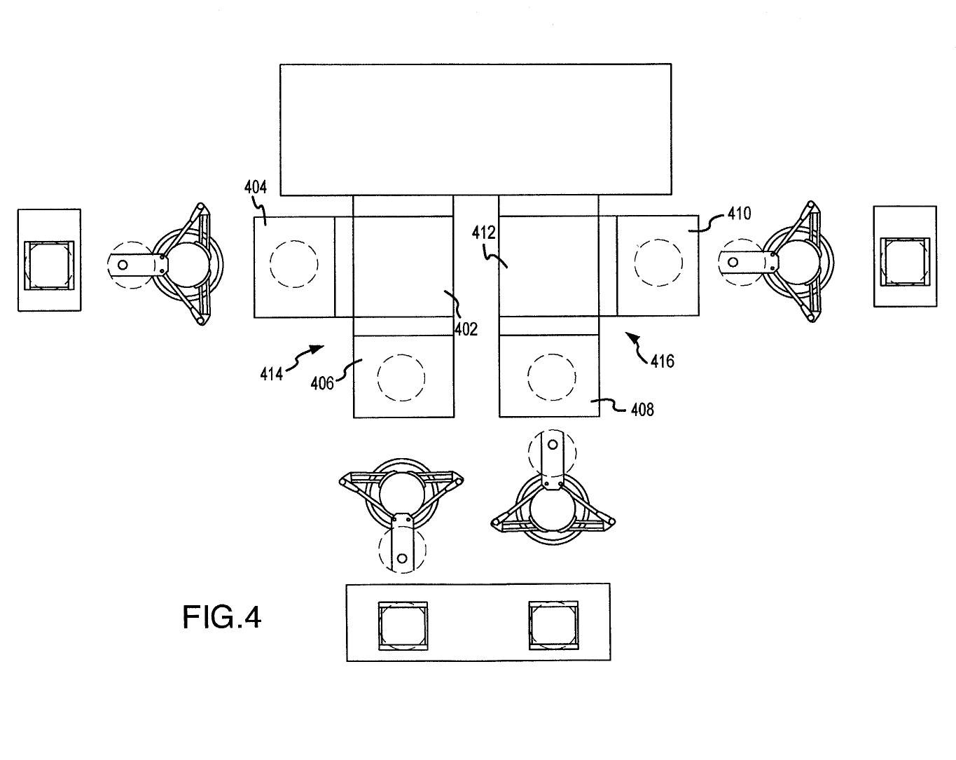

FIG. 4 is a plan view of yet another embodiment of a cluster tool utilizing load lock structures in accordance with the present invention. Specifically, the orthogonal orientation of antechambers 404 and 406 relative to main load lock chamber 402, and the orthogonal orientation of antechambers 408 and 410 relative to main load lock chamber 412, permits load locks 414 and 416 to be positioned side-by-side, without interference in efficient utilization of the antechambers.

Having fully described several embodiments in accordance with the present invention, many other equivalent or alternative embodiments of the present invention will be apparent to those skilled in the art. For example, while the above description focuses upon a load lock featuring antechambers oriented in a common horizontal plane, the invention is not limited to this configuration. Other load lock architectures are possible, including antechambers oriented in a common vertical plane and serviced by a vertically-oriented robot or device.

Accordingly, FIG. 5 presents a perspective view of yet another embodiment of a load lock structure 500 in accordance with the present invention. The orientation of antechambers 502, 504, 506, 508, and 510 relative to main load lock chamber 512 permits staging of four different batches of wafers during processing by tool 514.

Moreover, while the embodiments shown in FIGS. 3 and 4 show each load lock antechamber as loaded/unloaded by a devoted robot, this is not required by the present invention. Alternative embodiments in accordance with the present invention may utilize one robot to load/unload more than one or even all of the load lock antechambers.

In addition, while embodiments in accordance with the present invention have been described so far in connection with maximizing tool efficiency through wafer evacuation/venting pressurization, a variety of other pre- or post-processing activities may be hosted by load lock chamber embodiments in accordance with the present invention.

For example, many fabrication processes are performed at high temperatures and require heating of the wafer prior to its exposure to reactive environments. Accordingly, in certain applications it may be valuable to pre-heat the wafer through exposure to a heat source in the antechamber prior to the wafer's introduction to the processing chamber, thereby minimizing wafer thermal stabilization time in the chamber itself. Accordingly, the apparatus of FIG. 2 shows heating elements 223 associated with antechambers 204 and 206. Preheating of wafers utilizing heat sources such as hot gases can also occur within antechambers in accordance with embodiments of the present invention.

Exposing wafers to a particular gas constitutes another example of a pre- or post-processing activity that may take place in a load lock antechamber in accordance with the present invention. For example, in certain processing stages it is desirable to replace existing gases surrounding a wafer with a new processing gas ambient. This may be done by exposing the wafers/cassettes to a purge gas which displaces an existing gas around the wafers. The purge gas can in turn be replaced with another processing gas. Purge gases are typically inert, and examples include helium, argon, and nitrogen. Exposure to purge gases can take place in a load lock antechamber between processing stages rather than in the chamber itself, thereby maintaining high throughput in the chamber. Accordingly, the apparatus of FIG. 2 shows gas source 226 in communication with antechambers 204 and 206 through valves 224.

When a wafer is first introduced to a process gas, a period of equilibration takes place as the wafer and gas interact. Wafer processing is generally delayed until after this equilibration step is complete. By first exposing a wafer to a processing gas ambient within an embodiment of a load lock antechamber in accordance with the present invention, it is possible to reduce time required for gas equilibration to take place within the processing chamber shelf, thereby further enhancing throughput.

Wafer metrology is yet another pre- or post-processing activity that can be relegated to a load lock antechamber in accordance with an embodiment of the present invention. As is well known, various types of metrology instruments can be employed to analyze the physical properties of processed wafers. Examples of metrology instruments include four-point probes and laser inferometers. Such metrology instruments could be positioned proximate to a load lock antechamber in accordance with the present invention to interrogate a wafer positioned therein. Such analysis could take place in the antechamber before and after the discrete processing stages performed by a cluster tool. Accordingly, the apparatus of FIG. 2 shows metrology tool 228 in communication with antechamber 206.

Still another example of a pre- or post-processing activity that may be hosted by an antechamber in accordance with the present invention is wafer orientation. Incoming wafers could be physically aligned in a particular direction in the antechamber, thereby preventing this orientation step from consuming valuable time in the chamber prior to actual processing. Wafer center finding may also be performed in a load lock antechamber prior to introduction of a wafer to a processing chamber. Accordingly, the apparatus of FIG. 2 shows wafer orientation/center-finding tool 230 associated with antechamber 204.

While the above embodiments have been described in conjunction with a load lock for a cluster tool for semiconductor processing, the present invention is not limited to this particular configuration. A load lock including antechambers in accordance with embodiments of the present invention could also be positioned to perform various pre and post-processing tasks for a single-function semiconductor processing tool.

Having fully described several embodiments of the present invention, many other equivalent or alternative embodiments of the present invention will be apparent to those skilled in the art. These equivalents and alternatives are intended to be included within the scope of the present invention and the following claims.

What is claimed is:

1. An apparatus for processing a substrate comprising:
a plurality of processing chambers;
a central transfer chamber housing a first robot in selective communication with the processing chambers; and
a load lock comprising,
a main chamber including a second robot in selective wafer communication with the first robot through a first slit valve,
a first load lock antechamber configured to receive a first wafer batch, the first load lock antechamber in selective wafer communication with the second robot through a second slit valve, and
a second load lock antechamber configured to receive a second wafer batch, the second load lock antechamber in selective wafer communication with the second robot through a third slit valve,
the first load lock antechamber and the second load lock antechamber in fluid communication with a vacuum pump and selectively evacuable from the main chamber and from each other.

2. The apparatus of claim 1 wherein the first load lock antechamber and the second load lock antechamber are oriented linearly with respect to each other in a common plane with the main chamber.

3. The apparatus of claim 1 wherein at least one of the first load lock antechamber and the second load lock antechamber are oriented orthogonally with respect to each other in a common plane with the main chamber.

4. The apparatus of claim 1 wherein at least one of the first load lock antechamber and the second load lock antechamber are in communication with a pre- or post-processing apparatus selected from the group consisting of a heat source, a gas source, a wafer center-finding apparatus, a wafer orienting apparatus, and a metrology device.

5. The apparatus of claim 1 wherein the batch comprises a single wafer provided to the antechamber from a buffering table located outside the tool, the antechamber comprising a support member for receiving the wafer.

6. The apparatus of claim 1 wherein the batch comprises a plurality of wafers provided to the antechamber from a buffering table located outside the tool, the antechamber comprising a plurality of shelves for receiving the wafers.

7. The apparatus of claim 1 wherein the batch comprises an entire cassette of wafers provided to the antechamber from a buffering table located outside the tool, the antechamber comprising a support member for receiving the cassette.

8. The apparatus of claim 1 wherein one of the first and the second robot are selected from the group consisting of a rotatable robot, a shuttle robot, and an arm/knuckle robot.

9. A method of processing a substrate comprising:
loading a first substrate batch from a buffering table into a first load lock antechamber in selective communication with a main load lock chamber through a first slit valve;
utilizing a first robot positioned within the main load lock chamber to transfer a substrate from the first antechamber to the main load lock chamber while a second load lock antechamber in selective communication with the main load lock chamber through a second slit valve is loaded or unloaded with a second substrate batch; and
utilizing a second robot positioned within a transfer chamber of the cluster tool in communication with the load lock main chamber and with a processing chamber of the cluster tool, to transfer the substrate from the main load lock chamber to the processing chamber.

10. The method of claim 9 further comprising performing a pre- or post-processing step in at least one of the first load lock antechamber and the second load lock antechamber rather than in the processing chamber, thereby maximizing throughput of the processing chamber.

11. The method of claim 10 wherein evacuation and venting steps are performed in at least one of the first and second antechambers rather than in the processing chamber.

12. The method of claim 10 wherein a gas exposure step is performed in at least one of the first and second antechambers rather than in the processing chamber.

13. The method of claim 10 wherein a substrate center-finding step is performed in at least one of the first and second antechamber rather than in the processing chamber.

14. The method of claim 10 wherein a metrology step is performed in at least one of the first and second antechambers rather than in the processing chamber.

15. The method of claim 10 wherein a substrate orientation step is performed in at least one of the first and second antechambers rather than in the processing chamber.
